(19) United States
(12) Patent Application Publication
(10) Pub. No.: US 2008/0320381 A1
(43) Pub. Date: Dec. 25, 2008

(54) WEB APPLICATION HYBRID STRUCTURE AND METHODS FOR BUILDING AND OPERATING A WEB APPLICATION HYBRID STRUCTURE

(76) Inventor: Joel Sercel, Lake View Terrace, CA (US)

Correspondence Address: Steinfl & Bruno, 301 N Lake Ave Ste 810, Pasadena, CA, 91101, US

(21) Appl. No.: 12/140,825

(22) Filed: Jun. 17, 2008

Related U.S. Application Data
(60) Provisional application No. 60/936,370, filed on Jun. 20, 2007.

(51) Int. Cl. G06F 3/14

(52) U.S. Cl. 715/234

(57) ABSTRACT

A web application hybrid structure is disclosed. The structure combines third party content from third party websites with applications on the structure website into an integrated view. A blind template is developed on the web application hybrid site. The blind template comprises framing and organizing information for hosting of the third party content hosted on the one or more third party websites. The blind template does not comprise the third party data or content. Methods for operating and building the web application hybrid structure are also shown.

### CROSS REFERENCE TO RELATED APPLICATIONS

The present applications claims priority to U.S. Provisional App. Ser. No. 60/936,370 for “Blind Mashup” filed on Jun. 20, 2007, the contents of which are incorporated herein by reference in their entirety.

### FIELD

The present disclosure pertains to the field of web applications. In particular, it relates to a web application hybrid structure and methods for building and operating a web application hybrid structure.

### BACKGROUND

A mashup, or web application hybrid, is typically a type of website that combines content from more than one source into an integrated experience. By combining content from diverse sources into one integrated view, mashups allow users to synthesize data from multiple sources into integrated information that is intrinsically more valuable than the sum of the value of the two independent data sources. A typically-cited example combines geographic information from a web site such as Google Maps with commercial information such as real estate addresses and prices from Craig's List allowing a graphical display of where homes for sale in a given price range are to be found in a specified geographical area allowing the user to optimally plan a house hunting expedition.

The use of mashups is rapidly growing and is viewed as an important part of the Web 2.0 movement, where applications are built around the unique features of the Internet, as opposed to expecting the Internet to suit as a platform. Early mashups were developed using general purposed web development and programming tools. More recently major web companies such as Apple and Google have deployed development tools that allow mashups to be developed and deployed very rapidly, in some cases with drag and drop functionality.

As shown in the prior art structure of FIG. 1, the typical architecture of a web mashup, the mashup developer creates a web site (10) that is hosted on a server (20) accessible to the targeted user audience. The mashup site (10) links to one or more third party sites (30) to display fused information (40) to the user. Linkages (50) to the third party sites (30) can be, but are not limited to specific web services hosted on the third party site (an example would be Amazon Web Services—AWS) or through simple URL references to specific parts of third party web pages.

To be fully functional, the architecture shown in FIG. 1 requires that the client, the mashup server (20), and the third party sites (30) all be fully functional and viewable to each other within the same “security enclave”. As an example of this constraint, if either the hybrid mashup server or any of the third party sites mashed up on that server are behind a firewall (60) blocking user access, then the user experience will not be as designed.

### SUMMARY

According to a first aspect, a method for operating a web application hybrid structure that combines third party data or content from one or more third party websites into an integrated view is provided, comprising: developing a web application hybrid site by way of a template comprising framing and organizing information for hosting of said third party data or content without provision of said third party data or content; and combining said third party data or content with said template upon access of the web application hybrid site by one or more authorized users of the web application hybrid site, wherein said third party data or content is visible to the one or more authorized users of the web application hybrid site and is not visible to an unauthorized developer of web application hybrid site and unauthorized users of the web application hybrid site.

According to a second aspect, a method for building a web application hybrid structure that combines third party data or content from one or more third party websites into an integrated view is provided, comprising: developing a web application hybrid site by way of a template comprising framing and organizing information for hosting of said third party data or content, said template being devoid of said third party data or content.

According to a third aspect, a web application hybrid structure that combines third party data or content from one or more third party websites into an integrated view Is provided, comprising: a template developed on a web application hybrid site, the template comprising framing and organizing information for hosting of said third party data or content, the template not comprising said third party data or content; one or more web applications interfacing with the template, the one or more web applications hosted on the web application hybrid site; and said data or content, accessed from the one or more third party websites, wherein said data or content is visible to one or more authorized users of the web application hybrid site and is not visible to an unauthorized developer of the web application hybrid site and unauthorized users of the web application hybrid site.

Further embodiments of the disclosure, are present in the specification, claims and drawings of the present application.

### BRIEF DESCRIPTION OF THE DRAWINGS

FIG. 1 shows a schematic diagram showing a prior art example of a mashup environment.

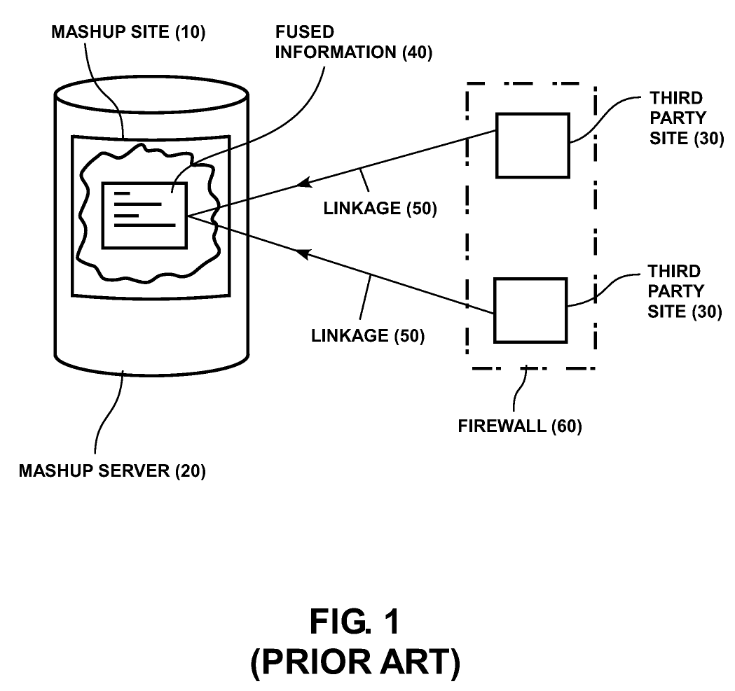

FIG. 2 shows a further schematic diagram with the teachings of an embodiment of the present disclosure.

### DETAILED DESCRIPTION

The present disclosure describes a blind mashup. The blind mashup is designed to circumvent the aforementioned limitation of conventional mashups associated with operation in contact with network security enclaves and/or firewalls. In accordance with the teachings of the present disclosure, a blind mashup respects the security intent and function of firewalls and other security features, but allows full fusion of content and the benefits of a mashup in those cases when the user has the privileges to see all the relevant data, even if the mashup developer does not. In the blind mashup of the present disclosure, the developer need not be able to view the content of the third party data and the third party data need not be accessible to the mashup server.

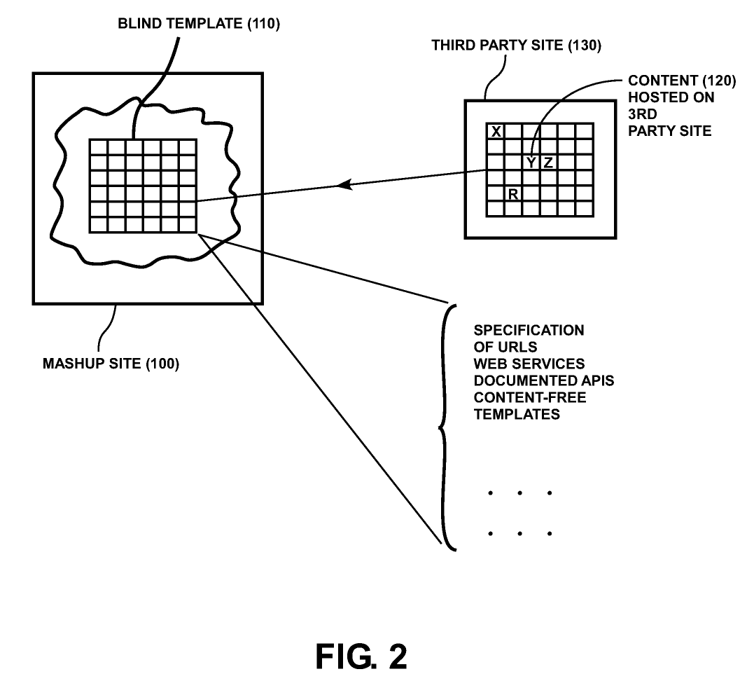

As shown in the schematic diagram of FIG. 2, the mashup site (100) according to the present disclosure is developed using a blind template (110) of the content (120) hosted on the third party site (130). Depending on the nature of the third party sites included in the blind mashup, the blind template (110) can be many things ranging from a specification of the appropriate URLs and web services (typically SOAP—Simple Object Access Protocol—and/or WSDL—Web Services Description Language), to documented APIs—Application Programming Interfaces—with example code, to content-free templates of html, XML, or a blank formatting template in the appropriate IDE (Integrated Development Environment) such as Adobe Flash Professional. Therefore, according to some embodiments of the present disclosure, the mashup developer is provided with the “structural” framing and organizing information necessary to build the mashup site (100) but not with the third party data or content (120) hosted on the third party site (130). If the third party sites (130) pre-date the blind mashup, then the templates (110) would be developed from the existing, populated content of the sites in question. On the other hand, if the blind mashup pre-dates the third party sites (130), then the developer of the mashup would also develop the blind templates (110).

### EXAMPLE

To illustrate an application of a blind mashup, it will now be described how it can be applied to a problem in which an enterprise user (e.g., AFRL—Air Force Research Laboratory) with security concerns is attempting to use an industrially-developed Web 2.0 portfolio analysis tool (RATE) to allow users within the enterprise to evaluate and rate information within the AFRL security enclave, which in this case is an intranet protected by a firewall. For the purposes of this illustration It will be hypothesized that: i) AFRL users within the firewall can read data from the .com domain through the firewall, ii) AFRL prefers to not run the RATE server within the firewall to avoid having to accreditate the system, iii) the firewall blocks content within the enterprise intranet from leaving through available web sockets.

In this case, the firewall would prevent the development of RATE if it were a conventional mashup operating outside the firewall because standard mashups require the developer to have access to the content of the third party web-sites they are integrating. However, if the RATE server is a blind mashup in accordance with the teachings of the present disclosure, the developer creates the mashup site (110) and the templates (110) to which the data content must conform. Because they are both content and executable free, the templates (110) can be transported across the firewall without violating AFRL regulations. Such transfer could be by FTP, sneaker-net, email attachments, or other means. AFRL personnel post content to the intranet using pre-arranged URLs by populating the provided templates.

When AFRL personal hit the RATE Blind Mashup site from within their firewall, they can see the framing and organizing information provided by the RATE developer, but they can also see the data and content. However, when someone outside the firewall hits the same site, the content is not visible and no proprietary information is disclosed. If the scenario for RATE were slightly different, and the content sites already existed, the same general approach would work, but the blind templates would have to be created within the firewall reflecting the already existing content and transmitted to the RATE developer for use in developing the RATE Blind Mashup site.

### Other Applications of Blind Mashups

There are numerous commercial and government applications of the concept of the Blind Mashup. Most applications involve developing a mashup site in which the developer is not permitted to view the content to be displayed. For example, an enterprise might wish to hire a developer to build a mashup that integrates a combination of proprietary and pubic information. Likewise, the government might want to use the blind mashup concept of the present disclosure to hire a contractor to integrate data that resides within different enclaves or compartments of a secure network enabling multi-source analysis. In this latter application, user authentication at run time would determine if particular information is displayed.

Accordingly, what has been shown is a web application hybrid structure and methods for building and operating a web application hybrid structure. While the structure and methods have been described by means of specific embodiments and applications thereof, it is understood that numerous modifications and variations could be made thereto by those skilled in the art without departing from the spirit and scope of the disclosure. It is therefore to be understood that within the scope of the claims, the disclosure may be practiced otherwise than as specifically described herein.

1. A method for operating a web application hybrid structure that combines third party data or content from one or more third party websites into an integrated view, comprising:
developing a web application hybrid site by way of a template comprising framing and organizing information for hosting of said third party data or content without provision of said third party data or content; and
combining said third party data or content with said template upon access of the web application hybrid site by one or more authorized users of the web application hybrid site,
wherein said third party data or content is visible to the one or more authorized users of the web application hybrid site and is not visible to an unauthorized developer of web application hybrid site and unauthorized users of the web application hybrid site.

2. The method of claim 1, wherein the template is developed anew by a web application hybrid developer.

3. The method of claim 1, wherein the template is developed from existing content of the one or more third party websites.

4. The method of claim 1, wherein the template comprises one or more entities selected from: URL specifications, web services specifications, documented APIs, content-free templates, and blank formatting template.

5. A method for building a web application hybrid structure that combines third party data or content from one or more third party websites into an integrated view, comprising:
developing a web application hybrid site by way of a template comprising framing and organizing information for hosting of said third party data or content, said template being devoid of said third party data or content.

6. A web application hybrid structure that combines third party data or content from one or more third party websites into an integrated view, comprising:
a template developed on a web application hybrid site, the template comprising framing and organizing information for hosting of said third party data or content, the template not comprising said third party data or content;
one or more web applications interfacing with the template, the one or more web applications hosted on the web application hybrid site; and
said data or content, accessed from the one or more third party websites, wherein said data or content is visible to one or more authorized users of the web application hybrid site and is not visible to an unauthorized developer of the web application hybrid site and unauthorized users of the web application hybrid site.
